(19) United States
(12) Patent Application Publication
(10) Pub. No.: US 2023/0367369 A1
(43) Pub. Date: Nov. 16, 2023

(54) ELECTRONIC DEVICES WITH FLEXIBLE DISPLAYS

(71) Applicant: HEWLETT-PACKARD DEVELOPMENT COMPANY, L.P., Spring, TX (US)

(72) Inventors: Hyunmin MOON, Spring, TX (US); Jin Cherl KWON, Spring, TX (US); Chanwoo PARK, Seoul (KR)

(21) Appl. No.: 17/745,407

(22) Filed: May 16, 2022

(51) Int. Cl. G06F 1/16

(52) U.S. Cl. CPC G06F 1/1652; G06F 1/1681; G06F 1/1641

(57) ABSTRACT

An example electronic device includes a base housing having a first portion and a second portion and a display housing including an upper portion and a lower portion. In addition, the electronic device includes a first hinge coupled between the lower portion and the base housing and a second hinge coupled between the lower portion and the upper portion. The first hinge and the second hinge define a plane that is parallel with the second portion when the lower portion is in a horizontal orientation. Further, the electronic device includes a flexible display panel disposed in the display housing.

### BACKGROUND

Electronic devices may be mobile electronic devices that are transportable from place to place. In addition, electronic devices may include a display panel that is to display images (e.g., text, graphics, video, pictures) during operations.

### BRIEF DESCRIPTION OF THE DRAWINGS

Various examples will be described below referring to the following figures:

FIG. 1 is a perspective view of an electronic device in an open position according to some examples;

FIG. 2 is a side view of the electronic device of FIG. 1 according to some examples;

FIG. 3 is a schematic top view of a base housing of the electronic device of FIG. 1 according to some examples;

FIG. 4 is a schematic, enlarged side view of a hinge of a display housing of the electronic device of FIG. 1 according to some examples;

FIG. 5 is a side view of the electronic device of FIG. 1 in a closed position according to some examples;

FIG. 6 is a side view of the electronic device of FIG. 1 in an open position according to some examples;

FIG. 7 perspective view of the electronic device of FIG. 1 in an open position according to some examples;

FIG. 8 is a side view of the electronic device of FIG. 1 in an open position according to some examples;

FIG. 9 is a perspective view of the electronic device of FIG. 1 in an open position according to some examples; and

FIG. 10 is a schematic block diagram of the electronic device of FIG. 1 according to some examples.

### DETAILED DESCRIPTION

A mobile electronic device may include a display panel that is to display images during operations. In some instances, an electronic device may incorporate a flexible display panel that can be deformed (e.g., rolled, folded, etc.) without losing electric functionality and connectivity.

To enhance a user's experience, a display panel may be as large as possible. However, the mobile nature of an electronic device (e.g., a mobile electronic device) places limits on the total size of the display panel. For instance, if a display panel is oversized, the overall dimensions of the electronic device may be too large to fit within standard sized receptacles (e.g., bags, pockets, sleeves) that are used for storing and transporting the mobile electronic device.

Accordingly, the examples disclosed herein include electronic devices having a flexible display panel and a plurality of housings pivotably coupled to one another so that that the electronic device may assume a compact, folded position for transportation and storage and a plurality of open, unfolded positions for viewing of a relatively large display panel during operations. Accordingly, through use of the example electronic devices disclosed herein, a user is able to enjoy a greater display surface area without sacrificing the overall transportability of the electronic device.

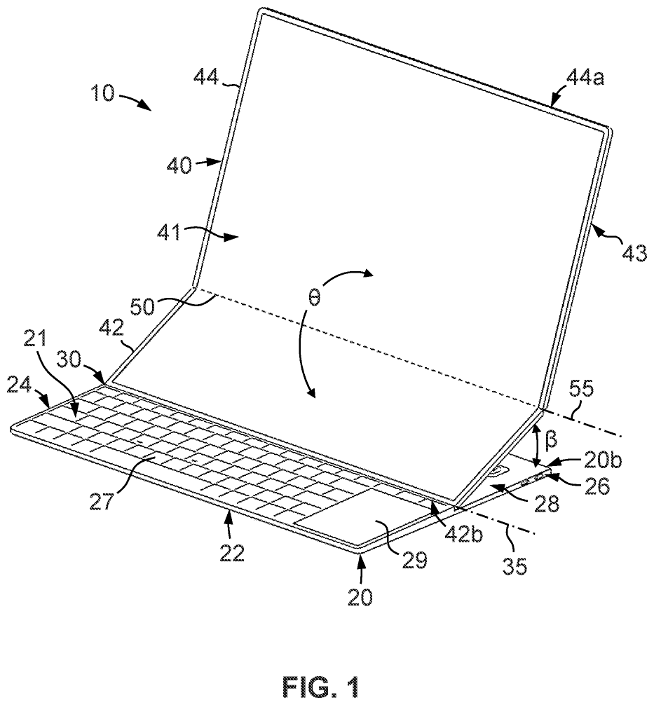

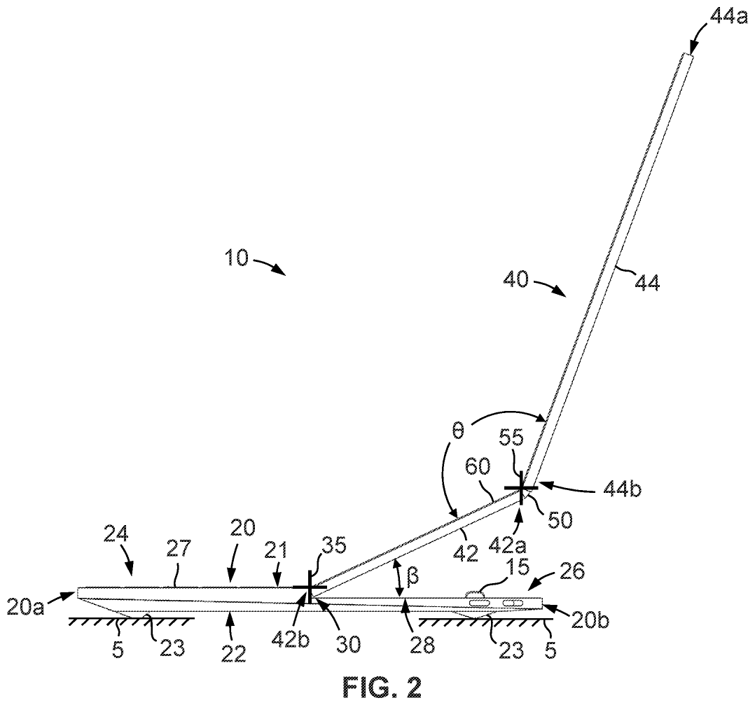

Referring now to FIGS. 1 and 2, an electronic device 10 according to some examples is shown. Electronic device 10 is a mobile electronic device, and as such may be readily transported from place to place. Electronic device 10 includes a base housing 20 and a display housing 40 coupled to one another. A display panel 60 is disposed in the display housing 40.

The base housing 20 includes a first or front end 20a, a second or back end 20b opposite the front end 20a, a top side 21 extending between the ends 20a, 20b, and a bottom side 22 opposite the top side 21 that also extends between ends 20a, 20b. The bottom side 22 may include one or more feet 23 that are to engage with a suitable support surface 5 during operations. The support surface 5 may comprise any suitable surface that is to support electronic device 10, such as, for instance a table, desk, floor, countertop, etc.

One or more user input devices 27, 29 are positioned on the top side 21. For instance, the electronic device 10 may include a keyboard 27 (e.g., a manual keyboard, a digital keyboard, etc.) and a touch sensitive surface 29 (e.g., a trackpad) that are positioned on top side 21. During operations, a user may manipulate or otherwise interact with the keyboard 27 and touch sensitive surface 29 to provide user inputs to the electronic device 10.

The base housing 20 is pivotably coupled to the display housing 40 at a first hinge 30. The first hinge 30 may include an axis of rotation 35, and the base housing 20 and the display housing 40 are to rotate about the axis of rotation 35 relative to one another via the first hinge 30. The first hinge 30 is positioned on the top side 21 and spaced between the front end 20a and the back end 20b of the base housing 20. Thus, the first hinge 30 separates or divides the base housing 20 (and particularly the top side 21) into a first portion 24 that extends from the front end 20a to the first hinge 30 and a second portion 26 that extends from the first hinge 30 to the back end 20b.

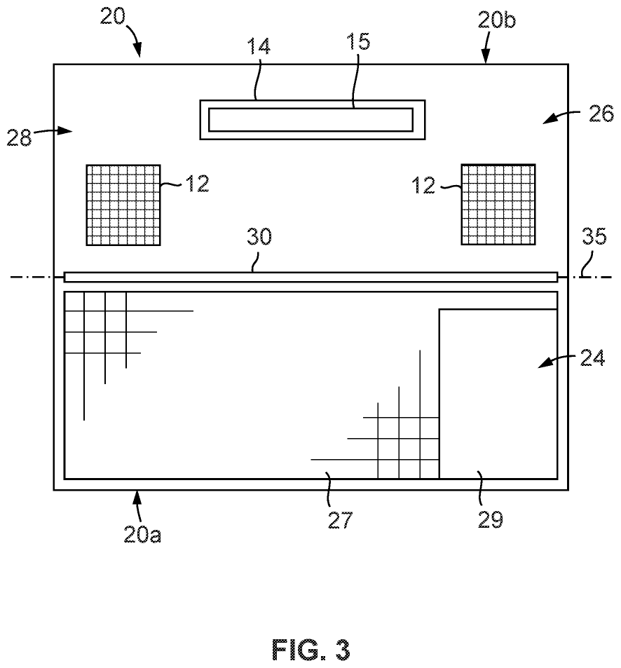

Referring now to FIGS. 2 and 3, the keyboard 26 and touch sensitive surface 28 are positioned in the first portion 24. In addition, the base housing 20 comprises a recess 28 that extends into the base housing 20 along top side 21. The recess 28 extends from the back end 20b to the first hinge 30, such that the recess 28 is positioned along (and may largely define) the second portion 26. Thus, the second portion 26 is recessed inward relative to the first portion 24 along top side 21.

As shown in FIG. 3, in some examples, a plurality of vents 12 are positioned in the recess 28 and second portion 26. The vents 12 provide a port for cooling air to flow into or out of the base housing 20 during operations. Specifically, the base housing 20 may contain one or more electronic components (e.g., controllers, processors, memories, printed circuit boards, etc.) that may generate heat during operations. Thus, the vents 12 allow air to flow into or out of the base housing 20 to remove heat from these various electronic components. In some embodiments, fans or other suitable components for forcibly moving air through the vents 12 (into or out of the base housing 20) may be mounted within the housing 20 on or adjacent the vents 12. Additional vents similar to the vents 12 may be arranged along bottom side 22 that also allow air to flow into or out of base housing 20 during operations.

In addition, a seat 14 for a user input device may be positioned within the recess 28 and second portion 26. The seat 14 may comprise a recess that extends inward from the second portion 26 (and thus inward from recess 28). The seat 14 may be sized and arranged to receive any suitable peripheral device 15, such as, for instance a stylus, mouse, etc. In some examples, the peripheral device 15 comprises a stylus 15 for making inputs on the touch sensitive surface 29 or the display panel 60 (e.g., for examples in which the display panel 60 is also a touch sensitive surface or component).

Referring again to FIGS. 1 and 2, the display housing 40 includes a front side 41 and a back side 43 that is opposite the front side 41. The front side 41 generally faces toward a user of the electronic device 10 during operations therewith (e.g., such as when electronic device 10 is in an open position such as shown in FIGS. 1, 2, 6, 7, 8, and 9 and described below).

In addition, the display housing 40 includes a first or lower portion 42 and a second or upper portion 44 pivotably coupled to the lower portion 42 via a second hinge 50. The display panel 60 continuously extends on the front side 41 within both the upper portion 44 and the lower portion 42. Thus, the second hinge 50 separates the display housing 40 into the lower portion 42 and the upper portion 44.

The second hinge 50 may have an axis of rotation 55, and the upper portion 44 and the lower portion 42 are to pivot about the axis of rotation 55 relative to one another during operations. The axis of rotation 55 of second hinge 50 is parallel to and radially offset from the axis of rotation 35 of first hinge 30.

The lower portion 42 includes a first or upper end 42a and a second or lower end 42b opposite lower end 42a. Likewise, the upper portion 44 includes a first or upper end 44a and a second or lower end 44b opposite upper end 44a. The first hinge 30 is coupled between the lower end 42b of lower portion 42 and the base housing 20, and the second hinge 50 is coupled between the upper end 42a of lower portion 42 and the lower end 44b of the upper portion 44.

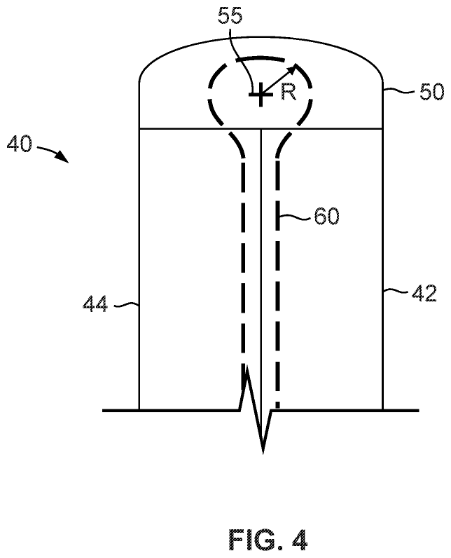

Referring now to FIG. 4, in some examples, the display panel 60 is a flexible display. As used herein, the term “flexible display panel” refers to electronic display panels that may be rolled, folded, etc. within a minimum radius of curvature without losing electrical function or connectivity. In some examples, the display panel 60 comprises a light-emitting diode (LED) display, such as, for instance an organic LED (OLED) display, a micro-LED display, etc.

Thus, the hinge 50 may guide or facilitate deformation of the display panel 60 when the upper portion 44 and lower portion 42 are rotated relative to one another about the hinge 50 to prevent damage to display panel 60. For instance, the upper portion 44 and lower portion 42 may be rotated about hinge 50 such that the portions 42, 44 are engaged with one another, and the hinge 50 may guide display panel 60 such that the display panel 60 may assume a minimum radius of curvature R that will prevent damage to the display panel 60.

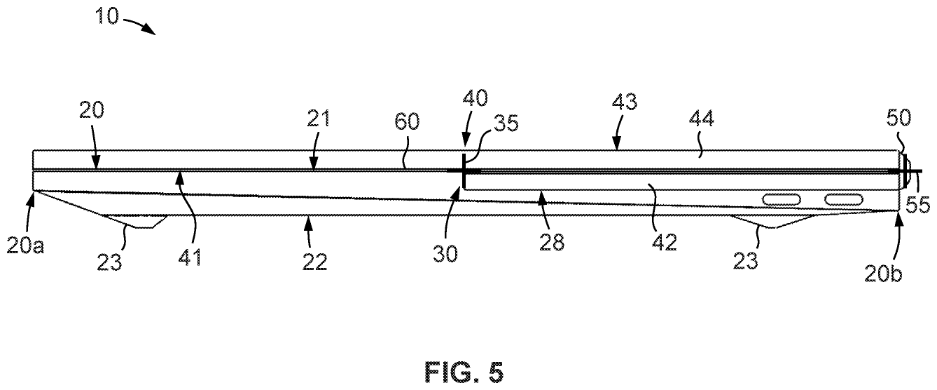

During operations, lower portion 42 of the display housing 40 may be rotated about the axis of rotation 35 via the first hinge 30, and the upper portion 44 may be rotated about the axis of rotation 55 via the second hinge 50 to allow the electronic device 10 to assume a number of positions. For instance, the electronic device 10 may be placed in a closed position as shown in FIG. 5. In the closed position, the lower portion 42 of the display housing 40 is rotated relative to the base housing 20 about the first hinge 30 to seat the lower portion 42 in the recess 48 such that the lower portion 42 of display housing 40 covers the second portion 28 of the base housing 20. In particular, the lower portion 42 may engage with the recess 28 along back side 43 of display housing 40 when in the closed position of FIG. 5 In some examples, the recess 28 is sized such that when the lower portion 42 of the display housing 40 is fully received in the recess 28 (e.g., such as in the closed position of FIG. 5), the lower portion 42 (or the portion of the display panel 60 disposed in the lower portion 42) may be flush with the top surface 21 of the base housing 20 within the first portion 24. Referring briefly to FIGS. 3 and 5, when the electronic device 10 is in the closed position 5, the lower portion 42 also covers the vents 12 and the seat 14 (and any peripheral device 15 stored in seat 14).

Referring still to FIG. 5, when the electronic device 10 is in the closed position, the upper portion 44 of the display housing 40 is rotated about the axis of rotation 55 of second hinge 50 relative to the lower portion 42 until the upper portion 42 covers the first portion 24 of the base housing 20 and the lower portion 42 of the display housing 40. Thus, in the closed position, the upper portion 44 and lower portion 42 of the display housing 40 covers the base housing 20. In particular, the upper portion 44 may engaged with the first portion 24 of the base housing 20 and lower portion 42 along front side 41 of display housing 40 when in the closed position of FIG. 5. When the electronic device 10 is resting on a horizontal support surface (e.g., support surface 5 in FIG. 2) in the closed position of FIG. 5, the lower portion 42 and the base housing 20 are both in a horizontal orientation, and the axis of rotation 35 of the first hinge 30 and the axis of rotation 55 define a plane (such that the axes of rotation 35 and 55 are positioned within the defined plane) that is parallel with the second portion 26 of base housing 20. Further, in the closed position of FIG. 5, the because the upper portion 44 of the display housing 40 covers the lower portion 42, the front side 41 of the display housing 40 and the display panel 60 are occluded from view.

The electronic device 10 assumes a compact shape when in the closed position of FIG. 5. Thus, the electronic device 10 may be stored in a suitable bag or case or may be more easily carried when in the closed position of FIG. 5. Moreover, by occluding the display panel 60 from view, the closed position of FIG. 5 may prevent damage to the display panel 60 during storage or transportation.

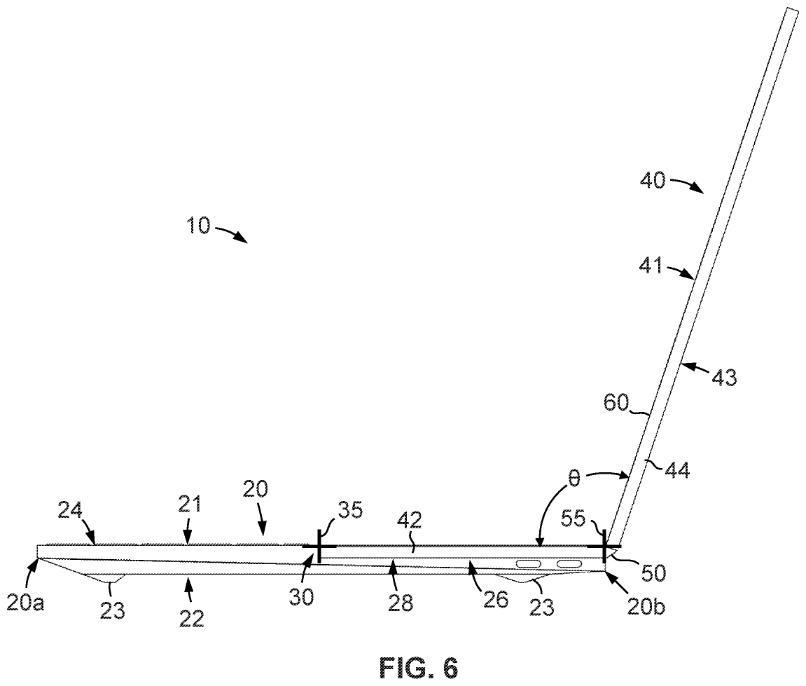

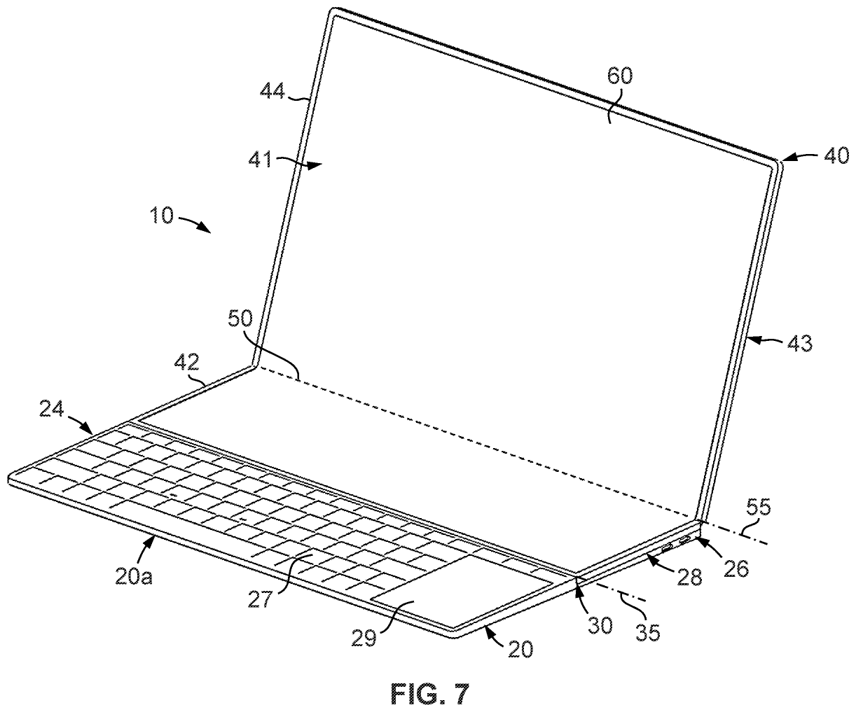

Referring now to FIGS. 6 and 7, the electronic device 10 may be placed in a first open position in which the upper portion 44 of the display housing 40 is rotated about the axis of rotation 55 of the second hinge 50 away from and relative to the lower portion 42 and the base housing 20 to expose the front side 41 of display housing 40 and display panel 60. The rotation of the upper portion 44 of the display housing 40 about the second hinge 50 increases an angle θ between the upper portion 44 and the lower portion 42 about the axis of rotation 55 on the front side 41 of the display housing 40. However, in the first open position of FIGS. 6 and 7, the lower portion 42 of the display housing 40 remains seated within the recess 28 such that the axes 35, 55 of rotation of the hinges 30, 50, respectively lie within a common plane that is parallel with the second portion 26 of the base housing 20, and the lower portion 42 covers the second portion 26 as previously described.

When the electronic device 10 is in the first open position of FIGS. 6 and 7, a user may view images on the display panel 60 both in the upper portion 44 and the lower portion 42 of the display housing 40. However, as will be described in more detail herein, because the upper portion 44 and lower portion 42 are at different angles and orientations (e.g., characterized by the angle θ), different images or information may be displayed on the portion of the display panel 60 within the upper portion 44 and the portion of the display panel 60 within the lower portion 42 during operations. In addition, in the first open position of FIGS. 6 and 7, a user may access the keyboard 27 and touch sensitive surface 29 to make suitable inputs on the electronic device 10.

The electronic device 10 may be transitioned from the first open position of FIGS. 6 and 7 to a second open position shown in FIGS. 1 and 2. As shown in FIGS. 1 and 2, in the second open position the lower portion 42 of the display housing 40 is rotated away from and relative to the base housing 20 about the axis of rotation 35 of first hinge 30 so that the lower portion 42 is unseated from the recess 28. Thus, in the second open position of FIGS. 1 and 2, an angle β between the lower portion 42 and the second portion 26 (or recess 28) of base housing 20 along the back side 43 of the display housing 40 is increased so that a user may more directly view images displayed on the portion of the display panel 60 disposed within the lower portion 42 of the display housing 40. However, in the second open position of FIGS. 1 and 2, the angle θ between the upper portion 44 and the lower portion 42 of display housing 40 may be maintained at less than 180° so that the display panel 60 is bent or folded at the second hinge 50.

As with the first open position of FIGS. 6 and 7, when the electronic device 10 is in the second open position of FIGS. 1 and 2, a user may view images on the display panel 60 both within the upper portion 44 and the lower portion 42 of the display housing 40. In addition, in the second open position of FIGS. 1 and 2, a user may access the keyboard 27 and trackpad 29 so as to make suitable inputs on the electronic device 10.

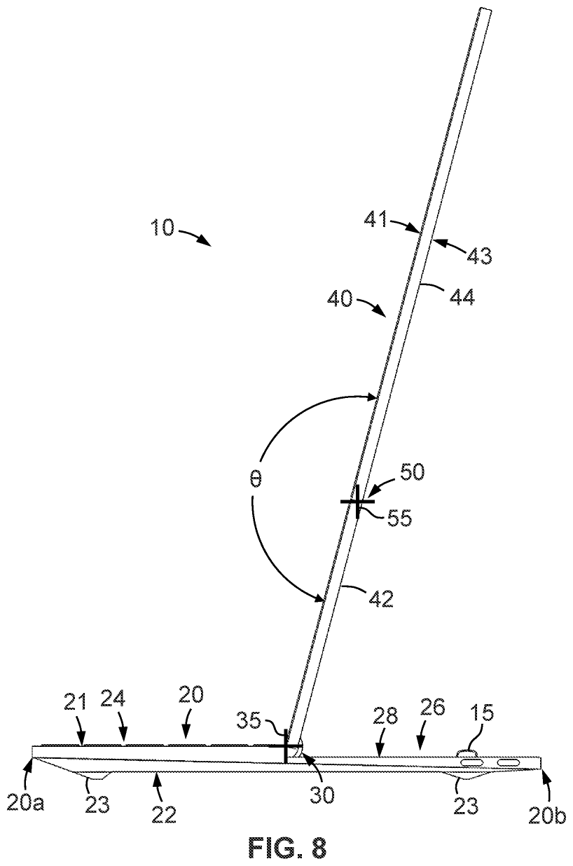

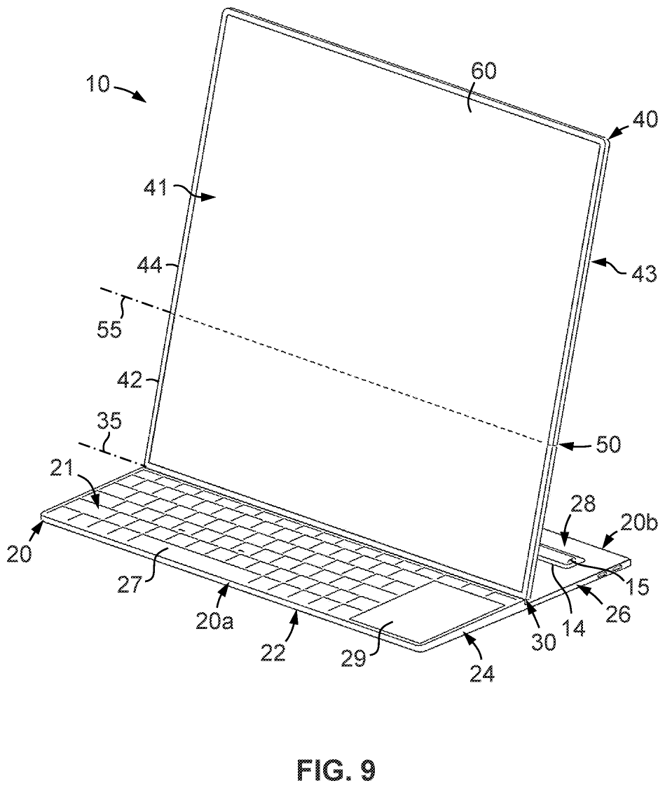

The electronic device 10 may be transitioned from the second open position of FIGS. 1 and 2 to a third open position shown in FIGS. 8 and 9. As shown in FIGS. 8 and 9, in the third open position the upper portion 44 is rotated relative to the lower portion 42 about the axis of rotation 55 of second hinge 50 so that the angle θ between the upper portion 44 and the lower portion 42 is approximately 180° and the display panel 60 is continuously flat or planar along front side 41 of display housing 40 within both the upper portion 44 and the lower portion 42. Thus, when the electronic device 10 is in the third open position of FIGS. 8 and 9, the upper portion 44 may be co-planar with the lower portion 42. A viewing angle of the display panel 60 may be adjusted via rotation of both the upper portion 44 and lower portion 42 of display housing 40 about axis of rotation 35 of first hinge 30 relative to base housing 20 when the electronic device is in the third open position of FIGS. 8 and 9.

When the electronic device 10 is in the third open position of FIGS. 8 and 9, a projected surface area of the display panel 60 may be maximized for a user. Thus, the third open position of FIGS. 8 and 9 may be associated with watching videos, playing video games, or any other operation that involves viewing images displayed on the display panel 60.

Referring briefly again to FIG. 3, as previously described, vents 12 and seat 14 are positioned within the recess 28. Thus, transitioning the electronic device from the closed position of FIG. 5 to the second open position of FIGS. 1 and 2 or the third open position of FIGS. 8 and 9 exposes the seat 14. As a result, when the electronic device is in the second open position of FIGS. 1 and 2 or the third open position of FIGS. 8 and 9, a user may retrieve the peripheral device 15 within seat 14 for use.

In addition, when the electronic device 10 is in the second open position of FIGS. 1 and 2 or the third open position of FIGS. 8 and 9, the vents 12 are also exposed so that air may flow therethrough to increase a rate of heat transfer from the various electronic components positioned within the base housing 20. Specifically, because the second open position of FIGS. 1 and 2 and the third open position of FIGS. 8 and 9 may project or angle both portions of the display panel 60 disposed in the upper portion 44 and the lower portion 42 toward the user for viewing images, these positions (e.g., in FIGS. 1, 2, 8, and 9) may be associated with image-based computing activities in which a user is viewing higher definition images on the display panel 60. Examples of such image-based computing activities include gaming and video watching. Such image-based computing activities may require elevated performance from the electronic components positioned within the base housing 20, which may result an increased rate of heat generation within base housing 20 during operations. As a result, the exposure of the vents 12 within recess 28 (e.g., when the electronic device 10 is transitioned to the second open position of FIGS. 1 and 2 or the third open position of FIGS. 8 and 9) may correspondingly increase an amount of airflow through the base housing 20 to ensure a suitable operating temperature of the base housing 20 and the electronic components positioned therein.

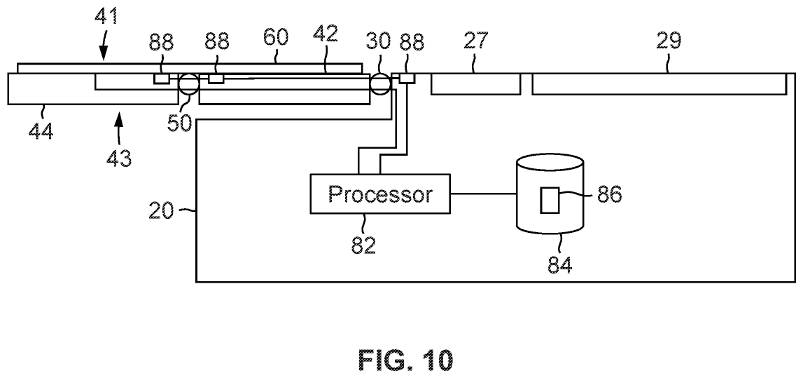

Referring now to FIG. 10, in some examples a controller 82 and a memory 84 may be positioned within electronic device 10 and communicatively coupled to one another. In addition, the controller 82 may be communicatively coupled to the display panel 60.

In FIG. 10, controller 82 is depicted as being positioned within the base housing 20. However, controller 82 may be positioned within display housing 40, including the upper portion 44 or the lower portion 42, or may be distributed among the base housing 20, the upper portion 44, and the lower portion 42 (or a subset of the base housing 20, the upper portion 44, and the lower portion 42) in various examples.

In some examples, controller 82 may comprise a microprocessor, a central processing unit (CPU), a controller within a microcontroller, etc. Controller 82 may execute machine-readable instructions 86 that are stored on the memory 84 (e.g., a non-transitory machine-readable medium), thereby causing the controller 82 to perform some or all of the actions attributed herein to the controller 82 (and, more generally, to the electronic device 10).

In some examples, the memory 84 may be positioned within the base housing 20 (e.g., such as is shown in FIG. 10). However, in some examples, the memory 84 may be positioned within the upper portion 44 or the lower portion 42 of display housing 40, or may be distributed among the base housing 20, upper portion 44, and the lower portion 42 (or a subset of the base housing 20, upper portion 44, and the lower portion 42). The memory 84 may comprise volatile storage (e.g., random access memory (RAM)), non-volatile storage (e.g., flash storage, etc.), or combinations of both volatile and non-volatile storage. Data read or written by the controller 82 when executing the machine-readable instructions 85 can also be stored on memory 84.

During operations, the controller 82 may determine whether the electronic device 10 is in the first open position of FIGS. 6 and 7, the second open position of FIGS. 1 and 2, or the third open position of FIGS. 8 and 9, and may adjust images that are displayed on the display panel 60 as a result of this determination. For instance, sensors 88 that are coupled to the display housing 40, the base housing 20, or a combination thereof may detect the positions of the upper portion 44 and lower portion 42 of display housing 40, and may communicate with the controller 82 during operations. The sensors 88 may comprise optical sensors, magnetic sensors (e.g., Hall-Effect sensors), accelerometers, etc. and may determine the rotational position of the lower portion 42 about the first hinge 30 relative to the base housing 20 and the relative, rotational positions of the upper portion 44 and the lower portion 42 about the second hinge 50.

Based on outputs from the sensors 88, the controller 82 may determine that the electronic device is in one of first open position of FIGS. 6 and 7, the second open position of FIGS. 1 and 2, or the third open position of FIGS. 8 and 9, and may adjust the images that are displayed via display panel 60 accordingly. For example, if the controller 82 determines, via the sensors 88, that the electronic device 10 is in the first open position of FIGS. 6 and 7 or the second open position of FIGS. 1 and 2, the controller 82 may adjust the display panel 60 such that a first image is presented on the portion of the display panel 60 in the upper portion 44 and a second image (that is different and non-continuous with the first image) is presented on the portion of the display panel 60 in the lower portion 42. Conversely, if the controller 82 determines, via the sensors 88, that the electronic device 10 is in the third open position of FIGS. 8 and 9, the controller 82 may adjust the display panel 60 such that a single continuous image is presented on both portions of display panel 60 in the lower portion 42 and the upper portion 44.

As described above, the examples disclosed herein include electronic devices that include a flexible display panel and a plurality of housings pivotably coupled to one another so that that the electronic device may assume a compact, folded position for transportation and storage and a plurality of open, unfolded positions that facilitate viewing of a relatively large display panel during operations. Accordingly, through use of the example electronic devices disclosed herein, a user is able to enjoy a greater display surface area without sacrificing the overall transportability of the device.

In the figures, certain features and components disclosed herein may be shown exaggerated in scale or in somewhat schematic form, and some details of certain elements are omitted in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein including in the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. An electronic device, comprising:
a base housing having a first portion and a second portion;
a display housing including an upper portion and a lower portion;
a first hinge coupled between the lower portion and the base housing;
a second hinge coupled between the lower portion and the upper portion, wherein the first hinge and the second hinge define a plane that is parallel with the second portion when the lower portion is in a horizontal orientation; and
a flexible display panel disposed in the display housing, wherein the flexible display continuously extends within the upper portion and the lower portion.

2. The electronic device of claim 1, wherein the base housing includes a recess in the second portion, wherein the lower portion is to rotate about the first hinge to seat the lower portion in the recess.

3. The electronic device of claim 2, wherein the base housing has a front end and a back end, wherein the first portion extends from the front end to the first hinge, and wherein the second portion extends from the first hinge to the back end.

4. The electronic device of claim 3, wherein the upper portion of the display housing is to rotate about the second hinge to cover the lower portion and the first portion of the base housing, wherein the upper portion engages with the lower portion when in a closed position.

5. The electronic device of claim 4, wherein the base housing includes a keyboard that is positioned in the first portion.

6. The electronic device of claim 2, wherein the first hinge has a first axis of rotation and the second hinge has a second axis of rotation, wherein the first axis of rotation is parallel to the second axis of rotation, wherein the second axis of rotation extends up to 180°.

7. The electronic device of claim 6, wherein the second portion of the base housing includes a vent, and wherein the lower portion is to cover the vent when the lower portion is in the horizontal orientation.

8. An electronic device, comprising:
a base housing;
a display housing having a lower portion and an upper portion;
a flexible display panel disposed in the display housing, wherein the flexible display continuously extends within the upper portion and the lower portion;
a first hinge to couple the base housing to the lower portion so that the first hinge separates the base housing into a first portion and a second portion; and
a second hinge to couple the lower portion to the upper portion;
wherein the lower portion is to rotate about the first hinge to cover the second portion; and
wherein the upper portion is to rotate about the second hinge to cover the first portion and the lower portion;
wherein the upper portion engages with the lower portion when in a closed position.

9. The electronic device of claim 8, wherein first hinge has a first axis of rotation and the second hinge has a second axis of rotation that is parallel to the first axis of rotation.

10. The electronic device of claim 9, wherein the second portion of the base housing comprises a recess, and wherein the lower portion is to rotate about the first hinge into the recess to cover the second portion.

11. The electronic device of claim 10, wherein the upper portion is to rotate about the second hinge to be co-planar with the lower portion.

12. The electronic device of claim 10, wherein the base housing comprises a vent that is positioned in the recess, and wherein the lower portion is to rotate about the first hinge to cover the vent.

13. The electronic device of claim 9, wherein the lower portion is to rotate about the first hinge so that the first axis of rotation and the second axis of rotation define a plane that is parallel with the second portion of the base housing.

14. The electronic device of claim 9, wherein the base housing comprises a keyboard positioned in the first portion.

15. An electronic device, comprising:
a base housing including a keyboard and a recess;
a display housing including a lower portion and an upper portion;
a flexible display panel disposed in the display housing, wherein the flexible display continuously extends within the upper portion and the lower portion;
a first hinge to couple the lower portion to the base housing, wherein the first hinge is positioned between the keyboard and the recess, and wherein the lower portion is to rotate about the first hinge to seat the lower portion within the recess; and
a second hinge to couple the lower portion to the upper portion;
wherein the second hinge has a second axis of rotation that extends up to 180°.

16. The electronic device of claim 15, wherein first hinge has a first axis of rotation and the second axis of rotation is parallel to the first axis of rotation, wherein the second hinge guides the flexible display panel such that the flexible display panel assumes a minimum radius of curvature that will prevent damage to the display panel.

17. The electronic device of claim 16, wherein when the lower portion is seated in the recess, the first axis of rotation and the second axis of rotation define a plane that is parallel with the base housing.

18. The electronic device of claim 15, wherein the upper portion is to rotate about the second hinge to cover both the lower portion and the keyboard when the lower portion is seated in the recess, wherein the upper portion engages with the lower portion when in a closed position.

19. The electronic device of claim 15, wherein the base housing includes a vent in the recess, wherein when the lower portion is seated within the recess, the lower portion covers the vent.

20. The electronic device of claim 19, wherein the base housing includes a seat in the recess that is to hold a peripheral device therein, and wherein when the lower portion is seated within the recess, the lower portion covers the seat and the peripheral device.
